(19) United States
(12) Patent Application Publication
(10) Pub. No.: US 2026/0321599 A1
(43) Pub. Date: Oct. 15, 2026

(54) ELECTROCHEMICAL DEVICE

(71) Applicant: Panasonic Intellectual Property Management Co., Ltd., Osaka (JP)

(72) Inventors: Hideo SAKATA, OSAKA FU (JP); Kenichi NAGAMITSU, KYOTO FU (JP); Shingo NAGATA, OSAKA FU (JP); Hiroshi KOBAYASHI, KYOTO FU (JP)

(21) Appl. No.: 19/491,494

(22) PCT Filed: Jun. 11, 2024
(86) PCT No.: PCT/JP2024/021234

§ 371 Date: Dec. 9, 2025

(30) Foreign Application Priority Data
Jun. 15, 2023 (JP) 2023-098324

(51) Int. Cl. H01M 4/36; H01M 4/02; H01M 4/58; H01M 4/587; H01M 10/0525; H01M 10/0565

(52) U.S. Cl. CPC H01M 4/366; H01M 4/5825; H01M 4/587; H01M 10/0525; H01M 10/0565; H01M 2004/021; H01M 2300/0082

(57) ABSTRACT

An electrochemical device includes a positive electrode, a negative electrode, and a lithium-ion-conductive electrolyte. The positive electrode contains a positive electrode active material. The positive electrode active material contains lithium transition metal oxide particles having a carbon layer on the surface. The negative electrode includes a negative electrode current collector and a negative electrode material layer supported on the negative electrode current collector. The negative electrode material layer contains a negative electrode active material that is reversibly doped with lithium ions. The negative electrode active material includes a carbon material. The surface layer portion of the negative electrode material layer has a coating region. When the coating region is measured by X-ray photoelectron spectroscopy, a peak is observed in the range of the binding energy of 530 to 534 eV in the O 1s spectrum. The intensity of the peak in the O 1s spectrum increases from the surface toward the interior of the coating region.

### TECHNICAL FIELD

The present invention relates to an electrochemical device.

### BACKGROUND ART

Electrochemical devices including a negative electrode material layer of a lithium-ion-doped carbon material are known (see Patent Literature 1). An electrochemical device includes a positive electrode, a negative electrode, and an electrolyte. It is known that a positive electrode material layer contains, as a positive electrode active material, a porous carbon material that is reversibly doped with anions, for example.

Patent Literatures 2 and 3 disclose lithium-ion secondary batteries in which a surface of the positive electrode active material is constituted by a lithium transition metal oxide coated with a carbon coating layer.

### CITATION LIST

### Patent Literature

[Patent Literature 1] International Publication No. 2022/181608
[Patent Literature 2] Japanese Laid-Open Patent Publication No. 2014-143041
[Patent Literature 3] Japanese Laid-Open Patent Publication No. 2013-149609

### SUMMARY OF INVENTION

### Technical Problem

In an electrochemical device using lithium ions, activated carbon whose main component is carbon and that has a large specific surface area is generally used for the positive electrode, and a carbon-based material capable of being doped with lithium ions is generally used for the negative electrode. In the electrochemical devices described above, a solid-state electrolyte interface film (i.e., a SEI film) is formed on the negative electrode material layer in charging and discharging. The SEI film plays a key role in the charge and discharge reactions. However, if the SEI film is formed excessively thick, the internal resistance of the electrochemical device is increased.

In view of the foregoing, lithium ions are pre-doped into the negative electrode prior to charging and discharging in the electrochemical device using lithium ions. Pre-doping is performed by forming metallic lithium in a film form on the surface of the negative electrode material layer, for example, by a vapor-phase method such as chemical vapor deposition, physical vapor deposition, or sputtering, or transfer. In this case, the SEI film is homogeneous and of appropriate thickness. Further, an additional reaction other than SEI film formation by decomposing the liquid electrolyte or an additive is less likely to occur. Therefore, the thickness can be reduced to reduce the internal resistance of the electrochemical device. However, lithium that cannot migrate into the interstitial space of the negative electrode remains on the surface, leading to production of a liquid electrolyte decomposition product such as carboxylate due to the lithium reacting with the liquid electrolyte.

As the liquid electrolyte decomposition product migrates to the positive electrode and reacts with the active sites on the positive electrode active material, the resistance of the positive electrode material layer is increased and the internal resistance of the electrochemical device tends to increase.

In particular, in an electrochemical device including a positive electrode active material layer containing a lithium transition metal oxide such as lithium iron phosphate as a positive electrode active material in order to increase the discharge capacity at high current density, the positive electrode active material is highly reactive with the liquid electrolyte decomposition product to increase the internal resistance.

### Solution to Problem

One aspect of the present disclosure relates to an electrochemical device including: a positive electrode; a negative electrode; and an electrolyte having lithium-ion conductivity, wherein the positive electrode includes a positive electrode current collector and a positive electrode material layer supported on the positive electrode current collector, the positive electrode material layer contains a positive electrode active material, the positive electrode active material contains particles of lithium transition metal oxide having a carbon layer on surface, the negative electrode includes a negative electrode current collector and a negative electrode material layer supported on the negative electrode current collector, the negative electrode material layer contains a negative electrode active material that is reversibly doped with lithium ions, the negative electrode active material includes a carbon material, a surface layer portion of the negative electrode material layer has a coating region, when the coating region is measured by X-ray photoelectron spectroscopy, a peak is observed in a range of binding energy of 530 to 534 eV in an O 1s spectrum, and an intensity of the peak in the O 1s spectrum increases from a surface to an interior of the coating region.

### Advantageous Effects of Invention

According to the present disclosure, an electrochemical device having favorable float properties can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a longitudinal sectional view of the configuration of an electrochemical device according to an embodiment of the present disclosure.

FIG. 2 is a graph showing a peak intensity A at the apex of the peak assigned to a bond of lithium carbonate in the O 1s spectrum, a peak intensity B at the apex of the peak in the F 1s spectrum, and change in peak intensity ratio A/B in the depth direction, in an electrochemical device A1 of Example 1.

FIG. 3 is graph showing a peak intensity A at the apex of the peak assigned to a bond of lithium carbonate in the O 1s spectrum, a peak intensity B at the apex of the peak in the F 1s spectrum, and change in peak intensity ratio A/B in the depth direction, in an electrochemical device A5 of Example 5.

FIG. 4 is graph showing a peak intensity A at the apex of the peak assigned to a bond of lithium carbonate in the O 1s spectrum, a peak intensity B at the apex of the peak in the F 1s spectrum, and change in peak intensity ratio A/B in the depth direction, in an electrochemical device A9 of Example 9.

FIG. 5 is graph showing a peak intensity A at the apex of the peak assigned to a bond of lithium carbonate in the O 1s spectrum, a peak intensity B at the apex of the peak in the F 1s spectrum, and change in peak intensity ratio A/B in the depth direction, in an electrochemical device B4 of Comparative Example 4.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. It should be noted that a known element of configuration may be employed as an element of configuration other than the characteristic parts of the present disclosure. In the present description, the phrase “a numerical value A to a numerical value B” means to include the numerical value A and the numerical value B. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one type of them may be selected and used singly, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

An electrochemical device according to an embodiment of the present disclosure includes a positive electrode, a negative electrode, and an electrolyte having lithium ion conductivity. Generally, the positive electrode and the negative electrode form an electrode body together with a separator provided therebetween. The electrode body is configured as a columnar wound body formed, for example, by winding the positive electrode and the negative electrode each having a band shape with the separator therebetween. Alternatively, the electrode body may be configured as a stacked body in which the positive electrode and the negative electrode each having a plate shape are stacked with the separator therebetween.

The positive electrode includes a positive electrode current collector and a positive electrode material layer supported on the positive electrode current collector. The positive electrode material layer contains a positive electrode active material that is reversibly doped and dedoped with anions of a lithium salt. The capacity of the electrochemical device can be increased as the amount of the anions of the lithium salt that can be doped and dedoped is increased.

The positive electrode active material contains particles of lithium transition metal oxide having a carbon layer on the surface. The lithium transition metal oxide, which undergoes reversible doping and dedoping of a large number of anions from the lithium salt, can increase the capacity of the electrochemical device. Formation of the carbon layer on the surface of the particles of the lithium transition metal oxide can improve the electronic conductivity to increase the discharge capacity at high current density. In addition, an increase in resistance caused by reaction between the active surface of the lithium transition metal oxide particles and the liquid electrolyte can also be suppressed to improve the float properties.

The thickness of the carbon layer formed on the surface of the particles of the lithium transition metal oxide is preferably 1.0 to 10 nm. As a result of the thickness of the carbon layer formed on the surface of the particles of the lithium transition metal oxide being within the above range, the conductivity of the surface of the particles of the lithium transition metal oxide can be increased. When the crystals of the lithium transition metal oxide contact each other via the carbon layer formed on the surface thereof, the crystals of the lithium transition metal oxide are electrically connected to each other, so that the conductivity of the positive electrode material layer can be increased.

The lithium transition metal oxide may include at least one selected from the group consisting of an olivine-type phosphate compound, a layered rock salt-type lithium transition metal composite oxide, and a spinel-type manganese oxide. Among these, the lithium transition metal oxide preferably includes at least one metal oxide selected from the group consisting of lithium iron phosphate, lithium manganese iron phosphate, lithium cobalt phosphate, lithium cobalt oxide, manganese spinel, lithium nickel oxide, and tertiary lithium nickel manganese cobalt oxide, and more preferably includes at least one metal oxide selected from the group consisting of lithium iron phosphate and lithium manganese iron phosphate. When the carbon layer is formed on the surface of lithium iron phosphate or lithium manganese iron phosphate, each of which has low electron conductivity, lithium iron phosphate or lithium manganese iron phosphate are further effective in increasing the discharge capacity at high current density through improvement in electron conductivity.

The negative electrode includes a negative electrode current collector and a negative electrode material layer supported on the negative electrode current collector. The negative electrode material layer contains a negative electrode active material that is reversibly doped with lithium ions. The negative electrode active material includes a carbon material.

Faraday reaction in which lithium ions are reversibly doped and dedoped proceeds in the carbon material to exhibit capacity. The lithium ion doping to the negative electrode active material is the concept that includes at least the doping phenomena of lithium ions to the negative electrode active material and can include, for example, adsorption of lithium ions to the negative electrode active material and chemical interactions between the negative electrode active material and lithium ions.

The surface layer portion of the negative electrode material layer has a coating region. The coating region is a region where an SEI film is formed. The SEI film contains lithium carbonate (Li₂CO₃). The SEI film containing lithium carbonate has low resistance to lithium ion migration. Accordingly, formation of the SEI film containing lithium carbonate as a main component can reduce the internal resistance of the electrochemical device. However, the SEI film containing lithium carbonate as a main component easily reacts with HF produced, for example, by the decomposition reaction of the liquid electrolyte, leading to collapse of the SEI film.

The SEI film can also contain lithium fluoride (LiF). A lithium fluoride-containing SEI film is stable to the liquid electrolyte and also less reactive with HF. However, a SEI film containing lithium fluoride as a main component is highly resistant to lithium ion migration and tends to increase the internal resistance of the electrochemical device.

When the coating region containing lithium carbonate is measured by X-ray photoelectron spectroscopy (XPS), a peak assigned to a bond of lithium carbonate is observed in the O 1s spectrum. The peak assigned to the bond of lithium carbonate is the peak assigned to a C═O bond (or C—O bond) of lithium carbonate and can appear in the range of the binding energy of 530 to 534 eV.

By contrast, when the coating region containing lithium fluoride is measured by X-ray photoelectron spectroscopy (XPS), a peak assigned to a bond of lithium fluoride is observed in the F 1s spectrum. The peak assigned to the bond of lithium fluoride is the peak assigned to an Li—F bond and can appear in the range of the binding energy of 684.8 to 685.3 eV.

In an electrochemical device according to an embodiment of the present disclosure, the intensity of the peak observed in the region of the binding energy of 530 to 534 eV in the O 1s spectrum increases from the surface toward the interior of the coating region. This means that lithium carbonate in the coating region is distributed locally such that it is abundantly present in the central part and the deep part (on the side close to the negative electrode active material) of the coating region in the depth direction and is reduce in amount in the surface of the coating region. As a result, the SEI film, which contains a large amount of lithium carbonate, is restricted from contacting the liquid electrolyte, thereby suppressing collapse of the SEI film while maintaining the resistance to lithium ions migration low.

By contrast, the intensity of the peak observed in the range of the binding energy of 684.8 to 685.3 eV in the F 1s spectrum can decrease from the surface toward the interior of the coating region, in the depth region where the intensity of the peak assigned to the bond of lithium carbonate in the O 1s spectrum increases from the surface toward the interior of the coating region. That is, a lithium-fluoride-rich SEI film can be formed on the surface of the coating region in contact with the liquid electrolyte. The lithium-fluoride-rich SEI film is stable to the liquid electrolyte and less likely to collapse. In addition, since a lithium-carbonate-rich SEI film is formed in the interior, the lithium-fluoride-rich SEI film can be thin and an increase in resistance to the lithium ion migration is suppressed.

In other words, the coating region includes a first layer that is formed on the surface contacting the liquid electrolyte and that contains a large amount of lithium fluoride, and a second layer that is present deeper than the first layer (on the side in contact with negative electrode active material) and that contains a large amount of lithium carbonate. The concentration (content per unit volume) of the lithium fluoride in the first layer is higher than the concentration of the lithium fluoride in the second layer. By contrast, the concentration (content per unit volume) of the lithium carbonate in the second layer is higher than the concentration of the lithium carbonate in the first layer. However, it is not required that there is a clear difference in the concentration of the lithium carbonate or the lithium fluoride at the boundary between the first layer and the second layer. The concentration of the lithium fluoride may gradually decrease from the first layer toward the second layer, and/or the concentration of the lithium carbonate gradually increases from the first layer toward the second layer.

Given that at any depth, A represents the peak intensity at the apex of the peak in the O 1s spectrum, and B represents the peak intensity at the apex of the peak in the F 1s spectrum. The distribution of the peak intensity B in the depth direction (thickness direction of the surface layer portion) can have an apex, which is the maximum, at the surface layer (first layer) of the coating region. On the other hand, in the distribution of the peak intensity A in the depth direction (thickness direction of the surface layer portion), the peak intensity increases toward the negative electrode active material side in the surface layer of the coating region and the highest apex can be located in the second layer located deeper (on the side closer to the negative electrode active material) than the surface layer. In this case, the peak intensity ratio A/B increases from the surface toward the interior in the coating region and then decreases. The peak intensity ratio A/B preferably reaches a maximum within the coating region. In this case, when the surface layer portion of the negative electrode material layer is measured by X-ray photoelectron spectroscopy, no peak assigned to the carbon material is substantially observed in the C 1s spectrum at a depth location where the peak intensity ratio A/B is at maximum.

Note that the peak assigned to the carbon material in the C 1s spectrum is a peak assigned to a C—C bond in the plane of graphite and can appear in the region of the binding energy of 281 to 283 eV. That no peak assigned to the carbon material is substantially observed means that even if a slight peak is observed, the peak intensity at its apex is 0.2 times or less the peak intensity A.

The maximum value of the peak intensity ratio A/B in the depth direction is, for example, 0.5 or more and 2 or less and may be 1 or more and 1.8 or less. The peak intensities A and B are each determined from the height of the peak from the baseline.

The lithium-carbonate-rich layer (second layer) may be formed in the surface layer portion of the negative electrode material layer prior to assembly of the electrochemical device. In the electrochemical device assembled with the negative electrode, a homogenous lithium-fluoride-rich first layer with an appropriate thickness can be formed, by charging and discharging thereafter, on the surface of the negative electrode active material by using the second layer as an underlayer. The first layer is formed by reaction of the negative electrode with a fluorine-containing electrolyte in the electrochemical device, for example. The second layer containing lithium carbonate has an action to promote the formation of the first layer, which is a favorable SEI film, and maintain the SEI film in a good condition under repeated charging and discharging.

The thickness of the lithium-fluoride-rich first layer should be, for example, 1 nm or more, or may be 3 nm or more, and a thickness of 5 nm or more is sufficient. However, when the thickness of the first layer exceeds 20 nm, the first layer itself can be a resistance component. Therefore, the thickness of the first layer may be 20 nm or less or 10 nm or less.

On the other hand, the thickness of the lithium-carbonate-rich second layer may be, for example, 1 nm or more, and may be 5 nm or more when a longer-term action is desired or may be 10 nm or more when a more reliable action is desired. However, when the thickness of the second layer exceeds 50 nm, the second layer itself can be a resistance component. Therefore, the thickness of the second layers may be 50 nm or less or 30 nm or less. For example, the thickness is 1 nm to 50 nm.

The thickness of the coating region (total thickness of the first layer and the second layer) is measured by analyzing the surface layer portion of the negative electrode material layer at a plurality of (at least five) locations on the negative electrode material layer. Then, the average thicknesses of the first layer and the second layer obtained at the locations should be the thickness of the first layer and the second layer, respectively. The negative electrode material layer to be used as a measurement sample may be one peeled off from the negative electrode current collector. In this case, a coating film formed on the surface of the carbon material, which forms the vicinity of the surface layer portion of the negative electrode material layer, should be analyzed. In this case, the carbon material coated with the coating film should be collected from the region of the negative electrode material layer located on the opposite side to the surface having been bonded to the negative electrode current collector, and used in the analysis.

In a negative electrode taken out of an electrochemical device that has been completed and undergone a predetermined aging or at least one cycle of charging and discharging, the surface portion of the negative electrode material layer or the coating film formed on the surface of the carbon material includes a SEI film (i.e., a first layer) produced in the electrochemical device. In this case, a peak assigned to lithium carbonate in the O 1s spectrum can be observed also in the first layer. It should be noted that the first layer and the second layer are distinguishable because the first layer, which is produced in the electrochemical device, has a composition different from that of the second layer, which is pre-formed prior to electrochemical device assembly. For example, by XPS spectrometry, an F 1s peak assigned to a bond of LiF is observed in the first layer, while no substantial F 1s peak assigned to the bond of LiF is observed in the second layer. Further, the amount of the lithium carbonate contained in the first layer is small. As a peak in the Li 1s spectrum, for example, a peak derived from a compound such as ROCO₂Li or ROLi can be detected.

When XPS analysis is performed on a coating region containing lithium carbonate, in addition to the peak (first peak) assigned to the C═O bond, a peak (second peak) assigned to an Li—O bond may be observed in the O 1s spectrum. It is considered that the region of the coating film present in the vicinity of the surface of the carbon material contains a small amount of LiOH or Li₂O.

Specifically, when the coating region is analyzed in the depth direction, a first region and a second region may be observed in the O 1s spectrum in the order of distance from the outermost surface of the surface layer portion. Here, the first region is a region in which the first peak (assigned to the C═O bond) and the second peak (assigned to the Li—O bond) are observed and the intensity of the first peak is higher than the intensity of the second peak. The second region is a region in which the first peak and the second peak are observed and the intensity of the second peak is higher than the intensity of the first peak. Further, a third region may be present that is closer in distance from the outermost surface of the surface layer portion than the first region and in which the first peak is observed but the second peak is not observed. The third region is likely to be observed when the second layer has a large thickness.

In the middle of the second layer in the thickness direction, the peak assigned to the C—C bond is substantially not observed in C 1s spectrum or has a peak intensity of less than half of the peak assigned to the C═O bond even if observed.

The XPS spectrometry of the surface layer portion of the negative electrode material layer is performed, for example, in a manner that the surface layer portion or the coating film formed on the surface of the carbon material is irradiated with an argon beam in the chamber of an X-ray photoelectron spectrometer, and changes in spectra assigned to C 1s electrons, O 1s electrons, and F 1s electrons with respect to the irradiation time are observed and recorded. In doing so, the spectrum of the outermost surface of the surface layer portion may be ignored from the viewpoint of eliminating analysis errors. The thickness of the region in which the peak assigned to lithium fluoride is stably observed corresponds to the thickness of the first layer. The thickness of the region in which the peak assigned to lithium carbonate is stably observed corresponds to the thickness of the second layer.

Next, a method for forming the coating region in the surface layer portion of the negative electrode material layer is described. First, a second layer containing lithium carbonate is formed in the surface layer portion of the negative electrode material layer. The formation of the second layer may be performed, for example, by a vapor-phase method, coating, or transfer.

Examples of the vapor-phase method include chemical vapor deposition, physical vapor deposition, and sputtering. For example, lithium carbonate may be deposited on the surface of the negative electrode material layer using a vacuum-deposition apparatus. The internal pressure of the apparatus chamber during deposition may be 10² to 10⁵ Pa, for example. The temperature of the lithium carbonate source may be 400 to 600° C. The temperature of the negative electrode material layer may be −20 to 80° C.

According to the coating, the second layer can be formed by applying a solution or a dispersion containing lithium carbonate to the surface of the negative electrode using, for example, a microgravure coater, followed by drying. The content of the lithium carbonate in the solution or the dispersion is 0.3 to 2% by mass, for example. When the solution is used, it is sufficient if the concentration is lower than the solubility (e.g., about 0.9 to 1.3% by mass in the case of an aqueous solution at room temperature).

Further, formation of the first layer containing lithium fluoride is performed so as to cover at least a part of the second layer to thus obtain a negative electrode. The surface layer portion of the thus obtained negative electrode material layer includes the first layer and the second layer. The first layer is formed to cover at least a part (preferably the entirety) of the surface of the negative electrode active material with the second layer therebetween (i.e., the second layer is used as an underlayer). The formation of the first layer, which is performed in a state in which the negative electrode material layer is in contact with the electrolyte, may also serve as at least a part of lithium ion pre-doping to the negative electrode material layer. For example, metallic lithium should be used as a source of lithium ions to be pre-doped.

Metallic lithium may be deposited on the surface of the negative electrode material layer (solid-phase doping). Exposure of the negative electrode including the negative electrode material layer with the metallic lithium deposited thereon to a carbon dioxide atmosphere can form a lithium carbonate-containing second layer having a thickness of, for example, 1 nm or more and 50 nm or less.

The deposition of metallic lithium on the surface of the negative electrode material layer can be performed by a vapor-phase method or transfer, for example. Examples of the vapor-phase method include chemical vapor deposition, physical vapor deposition, and sputtering. For example, metallic lithium may be formed in the form of a film on the surface of the negative electrode material layer using a vacuum deposition apparatus. The internal pressure of the apparatus chamber during deposition may be 10² to 10⁵ Pa, for example. The temperature of the lithium evaporation source may be 400 to 600° C. The temperature of the negative electrode mixture layer may be −20 to 80° C.

The carbon dioxide atmosphere is preferably a dry atmosphere containing no moisture, and may have, for example, a dew point of −40° C. or lower or −50° C. or lower. The carbon dioxide atmosphere can contain a gas other than carbon dioxide, but the molar fraction of carbon dioxide is preferably 80% or more, and more preferably 95% or more. It is desirable not to contain an oxidizing gas, and the mole fraction of oxygen may be 0.1% or less.

In order to form the second layer further thick, it is effective to set the partial pressure of carbon dioxide to, for example, greater than 0.5 atmospheres (5.05×10⁴ Pa). The partial pressure may be 1 atmosphere (1.01×10⁵ Pa) or more.

The temperature of the negative electrode exposed to the carbon dioxide atmosphere may be in the range of 15° C. to 120° C., for example. As the temperature is increased, the second layer becomes thicker.

The thickness of the second layer can be easily controlled by changing the time during which the negative electrode is exposed to the carbon dioxide atmosphere. The exposure time should be, for example, 12 hours or longer and should be shorter than 10 days.

Formation of the second layer is desirably performed prior to formation of the electrode body but does not exclude the case where the formation is performed after formation of the electrode body. That is, the second layer may be formed in the surface layer portion of the negative electrode material layer by preparing a positive electrode, preparing a negative electrode including a negative electrode material layer with metallic lithium deposited thereon, forming an electrode body using the positive electrode, the negative electrode, and a separator interposed therebetween, and then exposing the electrode body to the carbon dioxide atmosphere.

Lithium ion pre-doping to the negative electrode material layer further proceeds, for example, by bringing thereafter the negative electrode material layer in contact with the electrolyte and is completed by allowing it to stand for a predetermined period of time. Such pre-doping can be formation of the first layer to cover at least a part of the second layer. For example, at least one cycle of charging and discharging of the electrochemical device forms the first layer on the negative electrode material layer and can complete the lithium ion pre-doping to the negative electrode. Alternatively, for example, the lithium ion pre-doping to the negative electrode can be completed by applying a predetermined charge voltage (e.g., 3.4 to 4.0 V) between the terminals of the positive electrode and the negative electrode for a predetermined time period (e.g., 1 to 75 hours).

As described above, the solid-phase doping refers to a method of transferring lithium ions to the negative electrode active material by using the negative electrode material layer with metallic lithium deposited thereon, in the lithium ion pre-doping to the negative electrode material layer. In doing so, an SEI film (second layer) whose main component is lithium carbonate is formed in the surface layer portion of the negative electrode material. The lithium carbonate-containing SEI film, which has low resistance to lithium ion migration, can reduce the resistance of the negative electrode material layer.

Further, by charging and discharging thereafter, in the electrochemical device assembled with the negative electrode including the second layer, a stable coating film (first layer) containing a large amount of lithium fluoride and having an appropriate thickness is formed homogenously on the surface of the negative electrode active material with the second layer used as an underlayer. The first layer with the second layer formed thereunder can be thin, thereby suppressing an increase in resistance to lithium ion migration to suppress an increase in resistance of the negative electrode material layer.

In the solid-phase doping, while the resistance of the negative electrode material layer is reduced, a liquid electrolyte decomposition product such as carboxylate is produced by reaction of lithium that remains without migrating into the negative electrode active material and the liquid electrolyte. The liquid electrolyte decomposition product migrates to the positive electrode and reacts with the active sites present on the surface of the positive electrode active material. This tends to increase the resistance of the positive electrode material layer. In particular, in an electrochemical device using a positive electrode active material layer containing a lithium transition metal oxide as a positive electrode material layer, the positive electrode active material is highly reactive with the liquid electrolyte decomposition product, resulting in an increase in the internal resistance.

However, formation of the carbon layer on the surface of particles of the lithium transition metal oxide suppresses the reaction between the lithium transition metal oxide and the liquid electrolyte decomposition product. Accordingly, in an electrochemical device including a doped negative electrode produced by the solid-phase doping and a positive electrode containing a lithium transition metal oxide with a carbon layer formed on the surface of the particles thereof, an increase in the internal resistance can be suppressed to obtain favorable float properties.

By contrast, the liquid-phase doping refers to a method, as the lithium ion pre-doping to the negative electrode material layer, in which lithium ions are transferred into the negative electrode active material in a state in which the negative electrode material layer without the second layer is in direct contact with an electrolyte containing lithium ions. In doing so, decomposition reaction of the liquid electrolyte or the electrolyte, which occurs in parallel with the pre-doping, cannot be controlled. As a result, an SEI film in which lithium fluoride and lithium carbonate are present in a mixed state is formed. In addition, a SEI film formed by the liquid-phase doping is relatively thick, with a thickness of 70 nm or more. Therefore, by the liquid-phase doping, only the first layer whose main component is lithium fluoride can be formed in the surface layer portion of the negative electrode material layer. This SEI film is likely to increase the internal resistance of the electrochemical device due to the influence of lithium fluoride which has a high resistance to lithium ion migration.

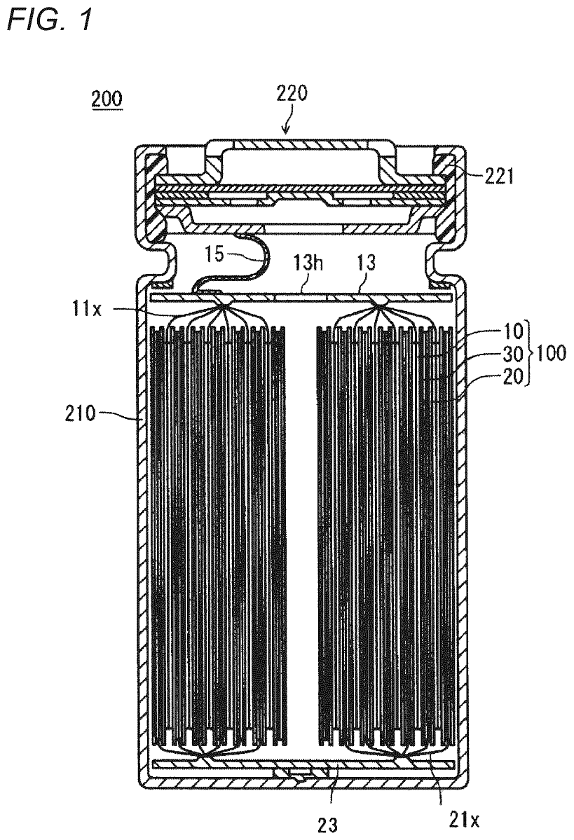

FIG. 1 schematically illustrates the configuration of an electrochemical device 200 according to an embodiment of the present disclosure. The electrochemical device 200 includes an electrode body 100, a nonaqueous electrolyte (not illustrated), a metal-made bottomed cell case 210 that houses the electrode body 100 and the nonaqueous electrolyte, and a sealing plate 220 that seals the opening of the cell case 210. A gasket 221 is provided at a periphery of the sealing plate 220. The inside of the cell case 210 is sealed by crimping the opening end of the cell case 210 to the gasket 221. A positive electrode current collector plate 13 having a through hole 13 h at the center is welded to a positive electrode core exposed portion 11x. One end of a tab lead 15 is connected to the inner surface of the sealing plate 220, the other one end of which is connected to the positive electrode current collector plate 13. In the above configuration, the sealing plate 220 has a function as an external positive electrode terminal. On the other hand, a negative electrode current collector plate 23 is welded to a negative electrode core exposed portion 21x. The negative electrode current collector plate 23 is directly welded to a welding member provided at the inner bottom surface of the cell case 210. In the above configuration, the cell case 210 has a function as an external negative electrode terminal.

Each of the components of an electrochemical device according to an embodiment of the present disclosure is further described below.

### (Negative Electrode)

The negative electrode includes a negative electrode current collector and a negative electrode material layer (negative electrode mixture layer) supported on the negative electrode current collector.

A sheet-shaped metallic material is used as the negative electrode current collector. The sheet-shaped metallic material may be a metal foil, a metal porous body, or an etched metal sheet, for example. As the metallic material, copper, a copper alloy, nickel, or stainless steel can be used, for example.

A negative electrode current collector plate is a substantially disk-shaped metal plate. The material of the negative electrode current collector plate is, for example, copper, a copper alloy, nickel, or stainless steel. The material of the negative electrode current collector plate may be the same as the material of the negative electrode current collector.

### (Negative Electrode Material Layer)

The negative electrode material layer contains, as a negative electrode active material, a carbon material that is electrochemically doped and dedoped with lithium ions. The carbon material is preferably graphite, non-graphitizable carbon (hard carbon), or graphitizable carbon (soft carbon), and particularly preferably graphite or hard carbon. The carbon material and another material may be used in combination.

The non-graphitizable carbon may have an interplanar spacing (i.e., spacing between carbon planes) d₀₀₂ of the (002) plane as measured by X-ray diffractometry of 3.8 Å or more. The theoretical capacity of the non-graphitizable carbon is desirably 150 mAh/g or more, for example. The use of the non-graphitizable carbon makes it easy to obtain a negative electrode that has a low DCR at low temperatures and that undergoes small expansion and contraction accompanying charging and discharging. Desirably, the non-graphitizable carbon occupies 50% by mass or more, more preferably 80% by mass or more, and even more preferably 95% by mass or more of the negative electrode active material. In addition, it is desirable that the non-graphitizable carbon occupies 40% by mass or more of the negative electrode mixture layer, more preferably 70% by mass or more, and even more preferably 90% by mass or more.

As the negative electrode active material, the non-graphitizable carbon and a material other than the non-graphitizable carbon may be used in combination. Examples of the material other than the non-graphitizable carbon that can be used as a negative electrode active material include graphitizable carbon (soft carbon), graphite (e.g., natural graphite or artificial graphite), lithium titanium oxides (e.g., spinel-type lithium titanium oxides), silicon oxides, silicon alloys, tin oxides, and tin alloys.

The average particle diameter of the negative electrode active material (particularly non-graphitizable carbon) is preferably 1 μm to 20 μm, and more preferably 2 μm to 15 μm, from the viewpoint of a high packing density of the negative electrode active material in the negative electrode and the ease of suppressing side reactions with the electrolyte.

In the present specification, the average particle diameter means a volume-based median diameter (D50) in a particle size distribution obtained by laser diffraction particle size measurement.

The negative electrode material layer contains a negative electrode active material as an essential component, and contains, for example, a conductive agent and a binder as optional components. Examples of the conductive agent include carbon black and carbon fibers. Examples of the binder include fluorocarbon resins, acrylic resins, rubber materials, and cellulose derivatives.

The negative electrode material layer is formed, for example, by mixing the negative electrode active material, the conductive agent, the binder, and the like together with a dispersion medium to prepare a negative electrode mixture slurry, applying the negative electrode mixture slurry to the negative electrode current collector, and then performing drying. The thickness of the negative electrode material layers is from 10 to 300 μm per side, for example.

The negative electrode material layer is pre-doped with lithium ions. This reduces the potential of the negative electrode to increase the potential difference (i.e., voltage) between the positive electrode and the negative electrode, thereby increasing the energy density of the electrochemical device. The amount of lithium to be pre-doped may be, for example, about 50% to 95% of the maximum amount of lithium ions that can be doped to the negative electrode material layer.

### (Positive Electrode)

The positive electrode includes a positive electrode current collector and a positive electrode material layer (positive electrode mixture layer) supported on the positive electrode current collector. A sheet-shaped metallic material is used as the positive electrode current collector. The sheet-shaped metallic material should be a metal foil, a metal porous body, or an etched metal sheet, for example. As the metallic material, aluminum, an aluminum alloy, nickel, or titanium can be used, for example.

A positive electrode current collector plate is a substantially disk-shaped metal plate. Preferably, a through hole serving as a passage for the nonaqueous electrolyte is formed in the central part of the positive electrode current collector plate. Examples of the material of the positive electrode current collector plate include aluminum, aluminum alloys, titanium, or stainless steel. The material of the positive electrode current collector plate may be the same as the material of the positive electrode current collector.

### (Positive Electrode Material Layer)

The positive electrode material layer contains, as a positive electrode active material, a positive electrode active material that is reversibly doped and dedoped with the anions of a lithium salt. The positive electrode active material contains lithium transition metal oxide particles having a carbon layer on the surface.

The following describes a method for preparing lithium transition metal oxide particles having a carbon layer on the surface. Specifically, they are obtained by charging powdery lithium transition metal oxide into an electric furnace and heating it, for example, in a tubular furnace or a muffle furnace in a reducing atmosphere at a temperature of 300 to 800° C. for 10 minutes to 8 hours under the flow of carbon dioxide gas or a hydrocarbon gas (e.g., acetylene gas or methane gas). In doing so, it is preferable that the treatment is performed by rotating the electric furnace to stir the metal oxide powder so that carbon layer is formed on the entire surface of the metal oxide particles. Further, in order to form a uniform and dense carbon layer, it is preferable to allow the reaction to proceed at a relatively low temperature of 300 to 500° C. for a long time of 1 to 5 hours, or to slow the reaction by mixing a small amount of nitrogen gas with the raw material gas. An electrochemical device using the lithium transition metal oxide particles having uniform and dense carbon layer is excellent in terms of float properties.

No particular limitations are placed on the lithium transition metal oxide as the base material. For example, at least one metal oxide selected from the group consisting of an olivine-type phosphate compound, a layered rock salt-type lithium transition metal composite oxide, and a spinel-type manganese oxide can be used. More specific examples thereof include powdery lithium iron phosphate, lithium manganese iron phosphate, lithium cobalt phosphate, lithium cobalt oxide, manganese spinel, lithium nickel oxide, and ternary lithium nickel manganese cobalt oxide, and mixtures of these.

Here, the thickness of the carbon layer can be performed, for example, by adjusting the gas flow rate of carbon dioxide, the treatment time, or the reaction temperature in the surface treatment. The thickness of the carbon layer can be limited to 1 to 10 nm because sufficient conductivity due to the formation of the carbon layer between the positive electrode active material particles cannot be obtained when the thickness of the carbon layer is less than 1 nm. Further, the decomposition product of the liquid electrolyte produced by reaction between the liquid electrolyte and the active surface of the positive electrode active material forms a coating film on the positive electrode active material to increase the resistance. This inhibits the electrochemical device using the above-described positive electrode from sufficiently achieving high discharge capacity. By contrast, when the thickness of the carbon layer exceeds 10 nm, the volume percentage of the carbon layer in the positive electrode material layer increases to reduce the density of the active material, and the carbon layer hinders lithium ion migration. Thus, the discharge capacity at high current density is reduced. The thickness of the carbon layer can be examined using a TEM-EELS (JEM-2010FEF manufactured by JEOL Ltd.).

The lithium transition metal oxide occupies desirably 50% by mass or more of the positive electrode active material, more desirably 80% by mass or more, and even more desirably 95% by mass or more. The lithium transition metal oxide occupies desirably 40% by mass or more of the positive electrode material layer, more desirably 70% by mass or more, and even more desirably 90% by mass or more.

The positive electrode material layer contains a positive electrode active material as an essential component, and contains, for example, a conductive agent and a binder as optional components. Examples of the conductive agent include carbon black and carbon fibers. Examples of the binder include fluorocarbon resins, acrylic resins, rubber materials, and cellulose derivatives.

The positive electrode material layer is formed, for example, by mixing the positive electrode active material, the conductive agent, the binder, and the like together with a dispersion medium to prepare a positive electrode mixture slurry, applying the positive electrode mixture slurry to the positive electrode current collector, and then performing drying. The thickness of the positive electrode material layers is 10 to 300 μm per side on the positive electrode current collector, for example.

### (Separator)

As the separator, a cellulose fiber-made nonwoven fabric, a glass fiber-made nonwoven fabric, a polyolefin-made microporous membrane, a woven fabric, or a nonwoven fabric can be used, for example. The thickness of the separator is, for example, 8 to 300 μm, and preferably 8 to 40 μm.

### (Electrolyte)

The electrolyte has lithium-ion conductivity and contains a lithium salt and a solvent for dissolving the lithium salt. The anions of the lithium salt repeatedly undergo reversible doping and dedoping to and from the positive electrode. Lithium ions derived from the lithium salt are reversibly doped and dedoped to the negative electrode.

Examples of the lithium salt include LiClO₄, LiBF₄, LiPF₆, LiAlCH, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LiN(SO₂CF₃)₂. These may be used alone or in a combination of two or more. The lithium salt is preferably a salt containing fluorine-containing anions because it has a high degree of dissociation, can yield a low-viscosity electrolyte solution, and can improve voltage resistance characteristics of the electrochemical device.

The electrolyte preferably includes an imide-based electrolyte. The imide-based electrolyte contains imide-based anions as the anions of the lithium salt. The imide-based anions may be anions containing fluorine and sulfur. In particular, lithium bis(fluorosulfonyl)imide, i.e., LiN(SO₂F)₂(LiFSI) is preferably used. For example, 80% by mass or more of the lithium salt may be LiFSI.

LiFSI is considered to be effective in suppressing degradation of the positive electrode active material and the negative electrode active material. Among salts containing fluorine-contain anions, FSI anions are excellent in stability. Therefore, it is considered that they are less likely to produce by-products and contribute to smooth charging and discharging without damaging the surfaces of the active materials. In addition, an SEI film of LiFSI formed in the surface layer portion of the negative electrode material layer contains a large amount of lithium fluoride and has a small content of lithium carbonate. Thus, a stable coating film (first layer) containing lithium fluoride as a main component can be formed to cover the second layer containing lithium carbonate as a main component.

The concentration of the lithium salt in the nonaqueous electrolyte in a charged state (state of charge (SOC) 90 to 100%) is 0.2 to 5 mol/L, for example.

Examples of the solvent that can be used include cyclic carbonates such as ethylene carbonate, propylene carbonate, and butylene carbonate, chain carbonates such as such as dimethyl carbonate, diethyl carbonate, and ethyl methyl carbonate, aliphatic carboxylic esters such as methyl formate, methyl acetate, methyl propionate, and ethyl propionate, lactones such as γ-butyrolactone and γ-valerolactone, chain ethers such as 1,2-dimethoxyethane (DME), 1,2-diethoxyethane (DEE), and ethoxymethoxyethane (EME), cyclic ethers such as tetrahydrofuran and 2-methyltetrahydrofuran, dimethyl sulfoxide, 1,3-dioxolane, formamide, acetamide, dimethylformamide, dioxolane, acetonitrile, propionitrile, nitromethane, ethylmonoglyme, trimethoxymethane, sulfolane, methylsulfolane, and 1,3-propanesarton. These may be used alone or in combination of two or more.

Various additives may be contained in the electrolyte as necessary. For example, an unsaturated carbonate such as vinylene carbonate, vinyl ethylene carbonate, or divinyl ethylene carbonate may be added as an additive for forming a lithium-ion conductive coating film on the surface of the negative electrode.

### (Supplemental Remarks)

According to the above description of the embodiments, the following techniques are disclosed.

### (Technique 1)

An electrochemical device including:
a positive electrode; a negative electrode; and an electrolyte having lithium-ion conductivity,
wherein the positive electrode includes a positive electrode current collector and a positive electrode material layer supported on the positive electrode current collector,
the positive electrode material layer contains a positive electrode active material,
the positive electrode active material contains particles of lithium transition metal oxide having a carbon layer on surface,
the negative electrode includes a negative electrode current collector and a negative electrode material layer supported on the negative electrode current collector,
the negative electrode material layer contains a negative electrode active material that is reversibly doped with lithium ions,
the negative electrode active material includes a carbon material,
a surface layer portion of the negative electrode material layer has a coating region,
when the coating region is measured by X-ray photoelectron spectroscopy, a peak is observed in a range of binding energy of 530 to 534 eV in an O 1s spectrum, and
an intensity of the peak in the O 1s spectrum increases from a surface to an interior of the coating region.

### (Technique 2)

The electrochemical device according to Technique 1, wherein the lithium transition metal oxide includes at least one metal oxide selected from the group consisting of an olivine-type phosphate compound, a layered rock salt-type lithium transition metal composite oxide, and a spinel-type manganese oxide.

### (Technique 3)

The electrochemical device according to Technique 1 or 2, wherein a thickness of the carbon layer formed on the surface of the particles of the lithium transition metal oxide is 1.0 nm or more and 10 nm or less.

### (Technique 4)

The electrochemical device according to any one of Techniques 1 to 3, wherein when the coating region is measured by the X-ray photoelectron spectroscopy, a peak is observed in the range of the binding energy of 684.8 to 685.3 eV range in an F 1s spectrum, and
an intensity of the peak in the F 1s spectrum decreases from the surface toward the interior of the coating region.

### (Technique 5)

The electrochemical device according to Technique 4, wherein a ratio A/B of a peak intensity A at an apex of the peak in the O 1s spectrum to a peak intensity B at an apex of the peak in the F 1s spectrum increases from the surface toward the interior of the coating region and then decreases, and
when the surface layer portion of the negative electrode material layer is measured by the X-ray photoelectron spectroscopy, no peaks assigned to a bond of the carbon material are substantially observed in a C 1s spectrum at a depth from the surface of the coating region where the ratio A/B is at a maximum.

### (Technique 6)

The electrochemical device according to any one of Techniques 1 to 5, wherein the electrolyte includes an imide-based electrolyte.

### (Technique 7)

The electrochemical device according to Technique 6, wherein the imide-based electrolyte contains anions containing fluorine and sulfur.

### EXAMPLES

Hereinafter, the present invention is described more specifically based on examples, but the present invention is not limited to the examples.

### Example 1

### (1) Positive Electrode Active Material Preparation

As a positive electrode active material, a commercially available lithium iron phosphate (LFP) powder manufactured by Merck was used for Example 1.

### (2) Formation of Carbon Layer on Surface of Particles of Positive Electrode Active Material

A carbon layer was formed on the surface of the LFP particles by the following method.

The LFP powder was charged into an electric furnace and heated in a reducing atmosphere at 450° C. for 3 hours under the flow of acetylene gas. Thus, a LFP powder with a 3-nm thick carbon layer formed thereon was obtained.

### (3) Positive Electrode Production

A positive electrode mixture slurry was prepared by dispersing 90 parts by mass of the positive electrode active material obtained in (2) described above, 3 parts by mass of an acrylic rubber being a binder, 2 parts by mass of carboxymethyl cellulose being a thickener, and 5 parts by mass of Ketjen Black being a conductive material in water. The resulting positive electrode mixture slurry was applied to both surfaces of an etched aluminum foil (thickness: 20 μm) being a positive electrode current collector, and the resulting coating film was dried and rolled to form positive electrode material layers. Thus, a positive electrode was obtained. A positive electrode current collector exposed portion having a width of 10 mm was formed at an end portion of the positive electrode current collector along the longitudinal direction.

### (4) Negative Electrode Production

A negative electrode mixture slurry was prepared by dispersing 90 parts by mass of non-graphitizable carbon, 5 parts by mass of Ketjen black, 2 parts by mass of carboxycellulose, and 3 parts by mass of styrene-butadiene rubber in water. The resulting negative electrode mixture slurry was applied to both surfaces of a copper foil (8 μm thick) being a negative electrode current collector, and the resulting coating film was dried and rolled to form negative electrode material layers. Thus, a negative electrode was obtained.

Thereafter, a certain amount of metallic lithium for pre-doping was attached to the entire surface of each negative electrode mixture layer. The amount of lithium to be pre-doped was set such that the negative electrode potential in the nonaqueous electrolyte after the completion of the pre-doping was 0.2 V or less relative to the metallic lithium.

Thereafter, the interior of the apparatus chamber was purged with carbon dioxide to form a carbon dioxide atmosphere. This forms a coating film containing lithium carbonate in the surface layer portion of each negative electrode mixture layer. The dew point of the carbon dioxide atmosphere was set to −40° C. The molar fraction of the carbon dioxide was set to 100%. The internal pressure of the chamber was set to 1 atmosphere (1.01×10⁵ Pa). The temperature of the negative electrode exposed to the carbon dioxide atmosphere at 1 atmosphere was set to 25° C. The time for exposure of the negative electrode to the carbon dioxide atmosphere was set to 22 hours.

### (5) Electrode Body Production

The positive electrode and the negative electrode were wound into a columnar shape with a polypropylene-made separator (thickness: 20 μm) therebetween to form an electrode body having a discharge capacity of 1 A. In doing so, a positive electrode core exposed portion was made to protrude from one end surface of the wound body, and a negative electrode core exposed portion was made to protrude from the other end surface of the electrode body. A positive electrode current collector plate and a negative electrode current collector plate each having a disk shape were welded to the positive electrode core exposed portion and the negative electrode core exposed portion, respectively. Thereafter, the resulting electrode body was left to stand and held for 20 hours in a carbon dioxide atmosphere until lithium ions were doped between the lattices of the negative electrode.

### (6) Nonaqueous Liquid Electrolyte Preparation

A liquid electrolyte was prepared by dissolving a lithium salt in a solvent. As the solvent, a mixture of a cyclic carbonate and a chain carbonate was used. Propylene carbonate and ethyl methyl carbonate were used as the cyclic carbonate and the chain carbonate, respectively. Specifically, the solvent was prepared by mixing propylene carbonate and dimethyl carbonate in a volume ratio of 30:70. A nonaqueous electrolyte was prepared by dissolving LiFSI as the lithium salt in the resulting solvent at a concentration of 1.0 mol/L.

### (7) Electrochemical Device Assembly

The electrode body was housed in a bottomed cell case having an opening. A tab lead connected to the positive electrode current collector plate was connected to the inner surface of a sealing plate, and the negative electrode current collector plate was welded to the inner bottom surface of the cell case. After the nonaqueous electrolyte was injected into the cell case, the opening of the cell case was sealed with the sealing plate. Thus, an electrochemical device A1 as illustrated in FIG. 1 was assembled.

Thereafter, charging and discharging were performed for 10 cycles by applying a current of 1 A at a voltage range of 2.2 to 3.6 V in an atmosphere at 80° C. for aging. In doing so, a first layer containing a large amount of lithium fluoride can be formed on the surface of the negative electrode active material via the second layer as an underlayer.

### (8) Evaluation

### [Evaluation 1]

### (Measurement of Internal Resistance of Electrochemical Device)

The electrochemical device after the aging was subjected to constant current charging at a current of 1 A in an environment at −30° C. until the voltage reached 3.6 V, and then, held for 10 minutes with a voltage of 3.6 V kept applied. Thereafter, constant current discharging was performed at a current of 1 A in the atmosphere at −30° C. until the voltage reached 2.2 V.

Using the discharge curve (vertical axis: discharge voltage, horizontal axis: discharge time) obtained by the above discharge, a straight line was determined on the discharge curve in the range from 0.5 seconds to 2 seconds after the start of discharge by a first-order approximation, and a voltage VS was determined from the intercept of the approximate straight line. The value (V0-VS) obtained by subtracting the voltage VS from a voltage V0 at the start of discharge (at the time when 0 seconds elapsed from the start of discharge) was obtained as ΔV (V). An internal resistance (DCR) R1 (Ω) of the electrochemical device was obtained from the following equation (A) using ΔV (V) and a current Id at the time of discharge.

Internal resistance R1=ΔV/Id (A)

It can be said that the lower the post-float DCR, the more the increase in internal resistance is suppressed and the better the float properties.

### [Evaluation 2]

### (Measurement of Initial Capacity of Electrochemical Device)

The electrochemical device after the pre-doping was discharged at a current of 1 A in an atmosphere at 25° C. until the voltage reached 2.2 V, re-charged at a current of 1 A until the voltage reached 3.6 V, and then discharged at a current of 1 A until the voltage reached 2.2 V. The discharge capacity at that time was taken as a pre-float discharge capacity C1.

### [Evaluation 3]

### (Measurement of Post-Float Capacity of Electrochemical Device)

Next, a floating test was performed by holding the electrochemical device for 1000 hours with a constant voltage of 3.6 V applied thereto in an environment at 70° C. Thereafter, the device was discharged at a current of 1 A in an atmosphere at 25° C. for 2 hours until the voltage reached 2.2 V, and re-charged at a current of 1 A until the voltage reached 3.6 V. The discharge capacity when the device is discharged thereafter at a current of 1 A until the voltage reached 2.2 V was taken as a post-float discharge capacity C2.

Using C1 and C2 obtained above, the capacity retention ratio (%) was determined from the following equation (B).

Capacity retention rate=(C2/C1)×100 (B)

It can be said that the higher the capacity retention rate, the less the electrochemical device degrades by the floating test.

### Example 2 to 4 and Comparative Examples 1 to 3

Electrochemical devices A2 to A4 and B1 to B3 were produced by the same method as Example 1, except for the thickness of the carbon layer formed on the surface of the particles of LFP being a positive electrode active material. The positive electrode active materials with carbon layers different in thickness were prepared by changing the treatment conditions (gas flow rate and treatment time) in the formation of the carbon layer on the surface of the particles of the positive electrode active material. For B1, an electrochemical device was produced using an LFP powder with no carbon layer formed thereon.

The thicknesses of the carbon layers were measured using a TEM-EELS to confirm that each carbon layer was formed with uniform thickness.

The electrochemical devices A2 to A4 and B1 to B3 were produced and evaluated in the same manner as the electrochemical device production of Example 1, except for (2) Carbon Layer Formation on Surface of Particles of Positive Electrode Active Material.

Table 1 shows the carbon layer thickness, post-float DCR, and capacity retention rate of each of the electrochemical devices A1 to A4 and B1 to B3. In Table 1, each DCR is expressed as a relative value with the post-float DCR of the electrochemical device B1 being defined as 100. The electrochemical devices A1 to A4 are examples and the electrochemical devices B1 to B3 are comparative examples.

TABLE 1

| | | Type of | | | |
|---|---|---|---|---|---|
| | | positive | Carbon | | Post-float |
| | Electro- | electrode | layer | | capacity |
| | chemical | active | thickness | Post-float | retention |
| | device | material | (nm) | DCR (%) | rate (%) |
| Example 1 | A1 | LFP | 3.0 | 81.5 | 88.1 |
| Example 2 | A2 | | 1.0 | 88.2 | 78.0 |
| Example 3 | A3 | | 5.0 | 85.6 | 84.6 |
| Example 4 | A4 | | 10.0 | 89.4 | 84.2 |
| Comparative | B1 | | 0.0 | 100.0 | 51.2 |
| Example 1 | | | | | |
| Comparative | B2 | | 0.5 | 98.2 | 53.8 |
| Example 2 | | | | | |
| Comparative | B3 | | 12.0 | 141.3 | 84.9 |
| Example 3 | | | | | |

Each of A1 to A4 including a carbon layer having a thickness of 1 to 10 nm on the surface of the positive electrode active material had a low post-float DCR and a high post-float capacity retention rate. In particular, of A1 to A4 and B1 to B3, A1 including a carbon layer having a thickness of 3 nm was the most favorable in float properties and exhibited the least degradation in capacity. By contrast, each of B1 and B2 having a carbon layer thickness of less than 1.0 nm exhibited a higher post-float DCR and a lower post-float capacity retention rate than A1 to A4. However, in B3 including an excessively thick carbon layer exhibited a high post-float DCR.

This is presumably because the conductive paths between the particles of the active material are ensured insufficiently due to the insufficient thickness of the carbon layer on the surface of the positive electrode active material in each of B1 and B2. In addition, an increase in post-float DCR is presumed to be a result of degradation of the positive electrode active material by the reaction between the active surface of the positive electrode active material and the liquid electrolyte composition.

The low post-float DCR is presumed to be a result of suppression of the reaction between the surface of the positive electrode active material and the liquid electrolyte composition in A1 to A4, each of which had a sufficiently thick carbon layer formed on the surface of the positive electrode active material.

As to the post-float capacity retention rate, the active surface of the positive electrode active material was out of contact with the liquid electrolyte composition as a result of a sufficiently thick carbon layer being formed on the surface of the positive electrode active material. Therefore, a decrease in the post-float capacity retention rate due to the degradation of the positive electrode active material was suppressed.

By contrast, in the case in which the thickness of the carbon layer on the surface of the positive electrode active material is insufficient, the low capacity retention rate is presumed to be a result of degradation of the positive electrode active material by the reaction between the active surface of the positive electrode active material and the liquid electrolyte composition.

### Comparative Example 4 to 6

In the negative electrode production, pre-doping was performed by bringing the negative electrode into contact with a liquid electrolyte having lithium-ion conductivity, instead of attaching metallic lithium for pre-doping (hereinafter referred to as solid-phase doping). Specifically, a negative electrode and a working electrode (metal plate made of SUS) to which a lithium foil serving as a lithium ion source was attached was charged into a battery jar filled with a liquid electrolyte having lithium-ion conductivity, with a separator interposed between the negative electrode and the working electrode. Next, lithium ion doping to a carbon layer (hereinafter, referred to as liquid-phase doping) was performed by voltage application between a positive electrode and the negative electrode using the working electrode as the positive electrode.

A lithium foil and the negative electrode were wound into a columnar shape with a polypropylene-resin-made separator (thickness 20 μm) therebetween, and the liquid electrolyte prepared in Example 1 was added. A current was then applied to the negative electrode so that the voltage reached 0.2 V or less. Thus, a negative electrode doped with lithium ions was produced. The wound body was disassembled. The negative electrode that had been doped (hereinafter, referred to as doped negative electrode) was taken out. Then, the positive electrode used in Example 1 and the doped negative electrode were wound into a columnar shape with a polypropylene-resin-made separator (thickness: 20 μm) therebetween to form a wound body having a capacity of 1 A.

By the same method as Example 1, electrochemical devices B4 to B6 were produced using the above wound body and evaluated.

Table 2 shows the carbon layer thickness, and post-float DCR, and capacity retention rate of each of the electrochemical devices A1, B1 and B4 to B6. In Table 2, each DCR is expressed as a relative value with the post-float DCR of the electrochemical device B1 being defined as 100. The electrochemical device A1 is example and B1 and B4 to B6 are comparative examples.

TABLE 2

| | | Type of | | Negative | | |
|---|---|---|---|---|---|---|
| | | positive | Carbon | electrode | | Post-float |
| | | electrode | layer | pre- | | capacity |
| | Electrochemical | active | thickness | doping | Post-float | retention |
| | device | material | (nm) | method | DCR (%) | rate (%) |
| Example 1 | A1 | LFP | 3.0 | Solid- | 81.5 | 88.1 |
| Comparative | B1 | | 0.0 | phase | 100.0 | 51.2 |
| Example 1 | | | | doing | | |
| Comparative | B4 | | 3.0 | Liquid- | 125.3 | 40.6 |
| Example 4 | | | | phase | | |
| Comparative | B5 | | 0.0 | doping | 141.5 | 35.6 |
| Example 5 | | | | | | |
| Comparative | B6 | | 13.0 | | 180.4 | 21.5 |
| Example 6 | | | | | | |

The post-float DCR of each of the electrochemical devices B4 to B6 increased regardless of the presence or absence of the carbon layer on the surface of the positive electrode active material. This is presumably because the internal resistance increased in the negative electrode as a result of the use of the doped negative electrode produced by the liquid-phase doping.

Furthermore, the post-float capacity retention rate was low in each of the electrochemical devices B4 to B6 regardless of the presence or absence of the carbon layer on the surface of the positive electrode active material. This is presumably because due to the fact that an SEI film was formed nonuniformly on the surface of the doped negative electrode produced by the liquid-phase doping, a portion of the negative electrode active material was deactivated by the reaction between the liquid electrolyte and the active surface of the negative electrode active material where the SEI film was not formed.

Furthermore, B5 exhibited a higher post-float DCR and a lower post-float capacity retention rate than B4 due to the fact that no carbon layer was formed on the surface of the positive electrode active material and the doped negative electrode produced by the liquid-phase doping was used.

### Example 5

### (1) Positive Electrode Active Material Preparation

Lithium manganese iron phosphate (LMFP) was synthesized as a positive electrode active material by the following method and used in Example 5.

Lithium carbonate (Li₂CO₃), iron (II) oxalate dihydrate (FeC₂O₄·2H₂O), manganese (II) oxalate dihydrate (MnC₂O₄·2H₂O), and ammonium dihydrogen phosphate (NH₄H₂PO₄) were weighed as raw materials for LMFP so as to have a molar ratio of Li:Mn:Fe:P=1:0.5:0.5:1, and mixed using a ball mill.

In the ball milling (first time), EasyNano RMB II manufactured by AIMEX Co., Ltd. was used. Zirconia balls having a diameter of 1 mm and acetone as a solvent were charged, and the treatment was then performed under the conditions of a rotational speed of 1000 rpm and a rotational time of 1 hour.

After the mixture subjected to the ball mill treatment was dried, sintering was performed in a nitrogen atmosphere at 400° C. for 10 hours.

After the sintering, the sintered product was ground in a mortar. Acetone was added to the ground sintered product, and milling was performed again in the same manner as the first ball milling under the condition of a rotational speed of 3000 rpm and a rotational time of 1 hour using EasyNano RMB II.

After the second ball milling, sintered product ground again in the mortar was subjected to heat treatment in a nitrogen atmosphere at 550° C. for 1 hour to obtain LMFP (Mn:Fe=1:1).

### (2) Carbon Layer Formation on Surface of Particles of Positive Electrode Active Material

A positive electrode active material was prepared by forming a carbon layer on the resulting LMFP by the following method.

The LMFP synthesized by the above-described method was charged into an electric furnace and heated in a reducing atmosphere at a temperature of 400° C. for 1 hour under the flow of acetylene gas. Thus, an LMFP powder with a 4-nm thick carbon layer formed thereon.

An electrochemical device A5 was produced and evaluated by the same method as the processes in Example 1, except for (1) Positive Electrode Active Material Preparation and (2) Carbon Layer Formation on Surface of Particles of Positive Electrode Active Material.

### Examples 6 to 8 and Comparative Examples 7 to 9

Electrochemical devices A6 to A8 and B7 to B9 were produced according to the same processes as those for producing Example 5, except for the thickness of the carbon layer formed on the surface of the LMFP particles being a positive electrode active material. The positive electrode active materials including carbon layers having different thicknesses were prepared by changing the treatment conditions (gas flow rate and treatment time) in the carbon layer formation on the surface of the LMFP. The electrochemical device B7 was produced using LMFP with no carbon layer formed thereon.

The thicknesses of the carbon layers were measured using a TEM-EELS to confirm that each carbon layer was formed with uniform thickness.

Electrochemical devices A5 to A8 and B7 to B9 were produced according to the same processes as those for producing Example 1, except for (2) Carbon Layer Formation on Surface of Particles of Positive Electrode Active Material. Note that the electrochemical devices A5 to A8 and B7 to B9 that used LMFP as a positive electrode active material were aged by performing charging and discharging for 10 cycles with the voltage set in the range of 2.2 to 4.2 V. In addition, the applied voltage set for evaluation such as internal resistance measurement and capacity measurement for the electrochemical devices was also set to 4.2 V.

Table 3 shows the carbon layer thickness, post-float DCR, and post-float capacity retention rate of each of the electrochemical devices A5 to A8 and B7 to B9. In Tables 3, each post-float DCR (%) is expressed as a relative value with the post-float DCR of the electrochemical device B7 being defined as 100. The electrochemical devices A5 to A8 are examples and B7 to B9 are comparative examples.

TABLE 3

| | | Type of | | | |
|---|---|---|---|---|---|
| | | positive | Carbon | | Post-float |
| | Electro- | electrode | layer | | capacity |
| | chemical | active | thickness | Post-float | retention |
| | device | material | (nm) | DCR (%) | rate (%) |
| Example 5 | A5 | LFMP | 4.0 | 71.4 | 85.6 |
| Example 6 | A6 | | 1.0 | 77.4 | 72.5 |
| Example 7 | A7 | | 2.0 | 74.5 | 75.1 |
| Example 8 | A8 | | 10.0 | 78.1 | 80.7 |
| Comparative | B7 | | 0.0 | 100.0 | 46.8 |
| Example 7 | | | | | |
| Comparative | B8 | | 0.5 | 95.1 | 48.3 |
| Example 8 | | | | | |
| Comparative | B9 | | 12.0 | 143.6 | 79.6 |
| Example 9 | | | | | |

A5 to A8 having a carbon layer thickness of 1 to 10 nm exhibited a low post-float DCR and a high post-float capacity retention rate. In particular, A5 having a carbon layer thickness of 4 nm exhibited the most favorable float properties and showed the least capacity degradation among A5 to A8 and B7 to B9. By contrast, B7 and B8 having a carbon layer thickness of less than 1.0 nm exhibited a higher post-float DCR and a lower post-float capacity retention rate than those of A5 to A8.

The results for the post-float DCR and post-float capacity retention rate of the electrochemical devices A5 to A8 and B7 to B9 showed a tendency similar to the results of the electrochemical devices A1 to A3 and B1 to B3 in terms of relative magnitude relationship among the samples, although they differ in absolute value. This is presumed to be due to increased internal resistance and degradation of the active material caused by differences in the positive electrode active material used.

### Example 9

### (1) Positive Electrode Active Material Preparation

As a positive electrode active material, a commercially available ternary lithium nickel manganese cobalt oxide (NMC) manufactured by Merck was used in Example 9.

### (2) Carbon Layer Formation on Surface of Particles of Positive Electrode Active Material

A positive electrode active material was prepared by forming a carbon layer on the NMC by the following method. The NMC was charged into an electric furnace and heated in a reducing atmosphere at 450° C. for 1 hour under the flow of acetylenic gas. Thus, an NMC powder with a 2-nm thick carbon layer formed thereon.

An electrochemical device A9 was produced and evaluated according to the same processes in Example 1, except for (2) Carbon Layer Formation on Surface of Particles of Positive Electrode Active Material.

### Example 10 to 12 and Comparative 10 to 12

Electrochemical devices A10 to A12 and B10 to B12 were produced according to the same processes as in Example 9, except for the thickness of the carbon layer formed on the surface of the NMC particles being a positive electrode active material. The positive electrode active materials with different carbon layer thicknesses were prepared by changing the treatment conditions (gas flow rate and treatment time) in the process of forming the carbon layer on the surface of the NMC particles. The electrochemical device B10 was produced using NMC particles with no carbon layer formed thereon.

The thickness of the carbon layers was measured using a TEM-EELS to confirm that each carbon layer was formed with uniform thickness.

Electrochemical devices A9 to A12 and B10 to 12 were produced and evaluated according to the same processes as in Example 1, except for (2) Carbon Layer Formation on Surface of Particles of Positive Electrode Active Material. Note that the electrochemical devices A5 to A8 and B7 to B9 that used LMFP as a positive electrode active material were aged by performing charging and discharging for 10 cycles with the voltage set in the range of 2.2 to 4.3V. In addition, the applied voltage set for evaluation such as internal resistance measurement and capacity measurement for the electrochemical devices was also set to 4.3 V.

Table 4 shows the carbon layer thickness, post-float DCR, and post-float capacity retention rate of each of the electrochemical devices A9 to A12 and B10 to B12. In Table 4, each DCR is expressed as a relative value with the post-float DCR of the electrochemical device B10 being defined as 100. The electrochemical devices A9 to A12 correspond to Examples 9 to 12 and B10 to B12 correspond to Comparative Examples 10 to 12.

TABLE 4

| | | Type of | | | |
|---|---|---|---|---|---|
| | | positive | Carbon | | Post-float |
| | Electro- | electrode | layer | | capacity |
| | chemical | active | thickness | Post-float | retention |
| | device | material | (nm) | DCR (%) | rate (%) |
| Example 9 | A9 | NMC | 2.0 | 88.8 | 86.6 |
| Example 10 | A10 | | 1.0 | 89.7 | 84.3 |
| Example 11 | A11 | | 5.0 | 90.2 | 86.4 |
| Example 12 | A12 | | 10.0 | 91.6 | 86.7 |
| Comparative | B10 | | 0.0 | 100.0 | 78.6 |
| Example 10 | | | | | |
| Comparative | B11 | | 0.5 | 98.9 | 79.8 |
| Example 11 | | | | | |
| Comparative | B12 | | 12.0 | 163.6 | 85.2 |
| Example 12 | | | | | |

A9 to A12 in which the carbon layer formed on the positive electrode active material had a thickness of 1 to 10 nm exhibited a low post-float DCR and a high post-float capacity retention rate. However, when A9 to A12 were compared with B10 and B11 including a carbon layer having a thickness of less than 1.0 nm, the relative differences in post-float DCR and post-float capacity retention rate were smaller than in the cases using LFP or LMFP as the positive electrode active material. This is presumed to be due to the difference in conductivity of the positive electrode active material used.

That is, it is presumed that carbon layer formation on the surface is less effective on the post-float DCR and post-float capacity retention rate of the electrochemical device using the NMC particles as a positive electrode active material than of the electrochemical device using LFP or LMFP as a positive electrode active material since the NMC particles are less conductive than LFP and LMFP. In other words, the effects on the post-float DCR and post-float capacity retention rate by carbon layer formation on the surface of the positive electrode active material are significant in an electrochemical device using LFP or LMFP having low conductivity as a positive electrode active material.

### [Evaluation 4]

### (XPS Analysis of Coating Region)

After the aging was complete, the negative electrodes were taken out of the electrochemical devices A1, A5, and A9. The surface layer portion of each negative electrode material layer was analyzed by XPS for the C 1s spectrum (in the range of the binding energy of 281 to 283 eV), the O 1s spectrum (in which a peak appears in the range of the binding energy of 530 to 534 eV), and the F 1s spectrum (in which a peak appears in the range of the binding energy of 684.8 to 685.3 eV). An X-ray photoelectron spectrometer (trade name: PHI Quantera SXM, manufactured by ULVAC-PHI, Inc.) was used for the analyses. The measurement conditions are indicated below.
X-ray source: A1-mono (1486.6 eV) 15 kV/25 W
Measurement diameter: @100 μm
Photoelectron extraction angle: 45°
Etching conditions: acceleration voltage 2 kV, etch rate about 7.05 nm/min (in terms of SiO₂), raster area 2 mm×2 mm

### (Electrochemical Devices)

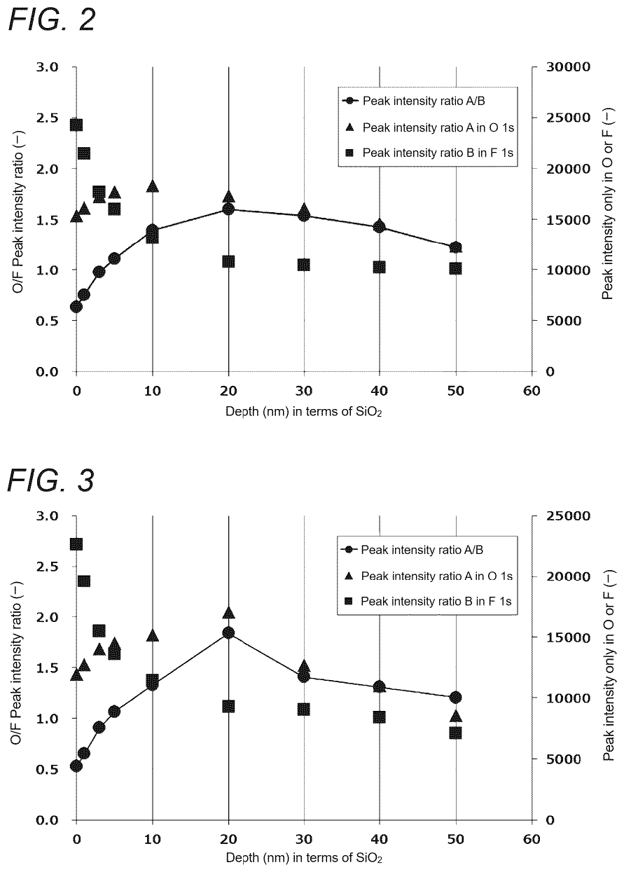

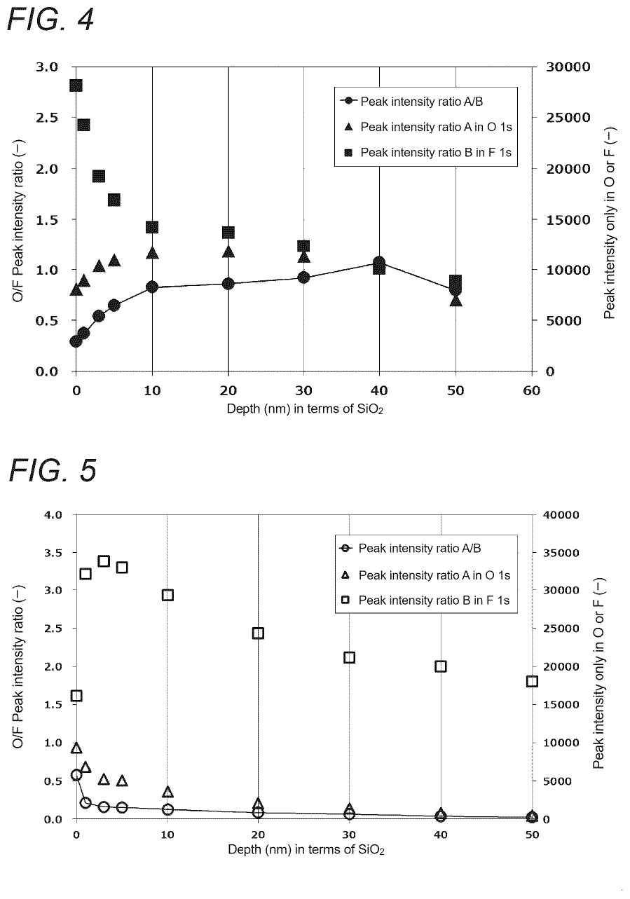

In the analysis of the coating regions by XPS, a peak intensity A at the apex of the peak appearing in the range of the binding energy of 530 to 534 eV was determined from the O 1s spectrum as the intensity of the peak assigned to the bond of lithium carbonate. From the F 1s spectrum, a peak intensity B at the apex of the peak appearing in the range of the binding energy of 684.8 to 685.3 eV was determined as the intensity of the peak assigned to the bond of lithium fluoride. The changes in peak intensity A, peak intensity B, and peak intensity ratio A/B in the depth direction (thickness direction of the surface layer portion) were measured while etching the surface layer portion of the negative electrode material layer. FIG. 2 shows the changes in peak intensity A, peak intensity B, and peak intensity ratio A/B in the thickness direction of the electrochemical device A1. FIG. 3 shows the changes in peak intensity A, peak intensity B, and peak intensity ratio A/B in the thickness direction of the electrochemical device A5. FIG. 4 shows the changes in peak intensity A, peak intensity B, and peak intensity ratio A/B in the thickness direction of the electrochemical device A9.

Referring to FIG. 2, in the electrochemical device A1 of Example 1, the peak intensity A (filled triangle in FIG. 2) assigned to the bond of lithium carbonate in the O 1s spectrum increases from the surface toward the interior (negative electrode active material side) of the coating region, reaches maximum at a depth of 10 nm in terms of SiO₂, and then decreases. By contrast, the peak intensity B (filled square in FIG. 2) assigned to the bond of lithium fluoride in the F 1s spectrum decreases from the surface toward the interior (negative electrode active material side) of the coating region. This means that an SEI film is formed such that a lithium fluoride-rich coating film (the first layer) covers a lithium carbonate-rich coating film (the second layer). The peak intensity ratio A/B (fille circle in FIG. 2) is 1.60 at a depth of about 20 nm in terms of SiO₂, which is a maximum value.

In the electrochemical device A1, a peak derived from the carbon material being a negative electrode active material was observed at a depth of 50 nm in terms of SiO₂ in the C 1s spectrum. Therefore, the thickness of the SEI film was evaluated as a thickness of 50 nm in terms of SiO₂.

Referring to FIG. 3, in the electrochemical device A5 of Example 5, the peak intensity A (fille triangle in FIG. 3) assigned to the bond of lithium carbonate in the O 1s spectrum increases from the surface toward the interior (negative electrode active material side) of the coating region, reaches maximum at a depth of 20 nm in terms of SiO₂, and then decreases. By contrast, the peak intensity B (filled square in FIG. 3) assigned to the bond of lithium fluoride in the F 1s spectrum decreases from the surface toward the interior (negative electrode active material side) of the coating region. This means that an SEI film is formed such that a lithium-fluoride-rich coating film (the first layer) covers a lithium-carbonate-rich coating film (the second layer). The peak intensity ratio A/B (filled circle in FIG. 3) is 1.84 at a depth of about 20 nm in terms of SiO₂, which is the maximum value.

In the electrochemical device A5, a peak derived from the carbon material being a negative electrode active material was observed at a depth of 60 nm in terms of SiO₂ in the C 1s spectrum. Therefore, the thickness of the SEI film was evaluated as a thickness of 60 nm in terms of SiO₂.

Referring to FIG. 4, in the electrochemical device A9 of Example 9, the peak intensity A (filled triangle in FIG. 4) assigned to the bond of lithium carbonate in the O 1s spectrum increases from the surface toward the interior (negative electrode active material side) of the coating region, reaches maximum at a depth of 20 nm in terms of SiO₂, and then decreases. By contrast, the peak intensity B (filled square in FIG. 4) assigned to the lithium fluoride bond in the F 1s spectrum decreases from the surface toward the interior (negative electrode active material side) of the coating region. This means that an SEI film is formed such that a lithium-fluoride-rich coating film (first layer) covers a lithium carbonate-rich coating film (second layer). The peak intensity ratio A/B (filled circle in FIG. 4) is 1.07 at a depth of about 40 nm in terms of SiO₂, which is a maximum value.

In the electrochemical device A9, a peak derived from the carbon material being a negative electrode active material was observed at a depth of 65 nm in terms of SiO₂ in C 1s spectrum. Therefore, the thickness of the SEI film was evaluated as a thickness of 65 nm in terms of SiO₂.

Referring to FIG. 5, in the electrochemical device B4 of Comparative Example 4, the peak intensity A (unfilled triangle in FIG. 5) assigned to the bond of lithium carbonate in the O 1s spectrum decreases from the surface toward the interior (negative electrode active material side) of the coating region. By contrast, the peak intensity (unfilled square in FIG. 5) assigned to the bond of lithium fluoride in the F 1s spectrum increases from the surface toward the interior (negative electrode active material side) of the coating region and then decreases. In the peak intensity ratio A/B (unfilled circle in FIG. 5), no maximum is observed in the change along the depth direction.

In the electrochemical device B4, a peak derived from the carbon material being a negative electrode active material was observed at a depth of 80 nm in terms of SiO₂ in the C 1s spectrum. Therefore, the thickness of the SEI film was evaluated as a thickness of 80 nm in terms of SiO₂.

### INDUSTRIAL APPLICABILITY

The electrochemical device according to the present invention is suitable, for example, for in-vehicle use.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

100: electrode body
10: positive electrode
11x: positive electrode core exposed portion
13: positive electrode current collector plate
15: tab lead
20: negative electrode
21x: negative electrode core exposed portion
23: negative electrode current collector plate
30: separator
200: electrochemical device
210: cell case
220: sealing plate
221: gasket

1. An electrochemical device comprising:
a positive electrode; a negative electrode; and an electrolyte having lithium-ion conductivity,
wherein the positive electrode includes a positive electrode current collector and a positive electrode material layer supported on the positive electrode current collector,
the positive electrode material layer contains a positive electrode active material,
the positive electrode active material contains particles of lithium transition metal oxide having a carbon layer on surface,
the negative electrode includes a negative electrode current collector and a negative electrode material layer supported on the negative electrode current collector,
the negative electrode material layer contains a negative electrode active material that is reversibly doped with lithium ions,
the negative electrode active material includes a carbon material,
a surface layer portion of the negative electrode material layer has a coating region,
when the coating region is measured by X-ray photoelectron spectroscopy, a peak is observed in a range of binding energy of 530 to 534 eV in an O 1s spectrum, and
an intensity of the peak in the O 1s spectrum increases from a surface to an interior of the coating region.

2. The electrochemical device of claim 1,
wherein the lithium transition metal oxide includes at least one metal oxide selected from the group consisting of an olivine-type phosphate compound, a layered rock salt-type lithium transition metal composite oxide, and a spinel-type manganese oxide.

3. The electrochemical device of claim 1,
wherein a thickness of the carbon layer formed on the surface of the particles of the lithium transition metal oxide is 1.0 nm or more and 10 nm or less.

4. The electrochemical device of claim 1,
wherein when the coating region is measured by the X-ray photoelectron spectroscopy, a peak is observed in the range of the binding energy of 684.8 to 685.3 eV range in an F 1s spectrum, and
an intensity of the peak in the F 1s spectrum decreases from the surface toward the interior of the coating region.

5. The electrochemical device of claim 4,
wherein a ratio A/B of a peak intensity A at an apex of the peak in the O 1s spectrum to a peak intensity B at an apex of the peak in the F 1s spectrum increases from the surface toward the interior of the coating region and then decreases, and
when the surface layer portion of the negative electrode material layer is measured by the X-ray photoelectron spectroscopy, no peaks assigned to a bond of the carbon material are substantially observed in a C 1s spectrum at a depth from the surface of the coating region where the ratio A/B is at a maximum.

6. The electrochemical device according to claim 1,
wherein the electrolyte includes an imide-based electrolyte.

7. The electrochemical device of claim 6,
wherein the imide-based electrolyte contains anions containing fluorine and sulfur.
